(19) United States
(12) Patent Application Publication
(10) Pub. No.: US 2022/0028361 A1
(43) Pub. Date: Jan. 27, 2022

(54) ENVIRONMENTALLY-REGULATED PORTABLE MUSICAL INSTRUMENT CASE

(71) Applicant: Jared Shanklin, Tolar, TX (US)

(72) Inventor: Jared Shanklin, Tolar, TX (US)

(21) Appl. No.: 17/380,968

(22) Filed: Jul. 20, 2021

Related U.S. Application Data
(60) Provisional application No. 63/054,720, filed on Jul. 21, 2020.

(51) Int. Cl. G10G 7/00; G06F 3/14; B32B 5/18; B32B 17/02; B32B 15/04

(52) U.S. Cl. CPC G10G 7/005; G06F 3/14; G01S 19/13; B32B 17/02; B32B 15/046; B32B 5/18

(57) ABSTRACT

An environmentally-regulated portable musical instrument case is provided which can insulate the musical instrument from external temperature and humidity changes. The case has an internal cavity designed to hold the musical instrument. The walls of the cavity are designed to reduce thermal transfer between the internal cavity and the surrounding environment. A temperature regulating apparatus actively or passively further controls the temperature of the internal cavity while a humidity control device controls the humidity.

### CROSS-REFERENCE TO RELATED APPLICATION

This application claims priority to U.S. Provisional Application No. 63/054,720, which was filed on Jul. 21, 2020, which is incorporated by reference herein in its entirety.

### FIELD OF THE INVENTION

This disclosure relates generally to musical instrument storage. More specifically, it relates to a portable musical instrument case.

### BACKGROUND

Environmental conditions can not only affect a musical instrument's sound but in extreme circumstances may even be damaging to the instrument. For example, an acoustic guitar built from wood may expand, shrink, or warp as the temperature and humidity changes, putting the instrument out of tune.

Musical instruments are frequently transported to venues for shows or on tours around the country or even world, exposing the instruments to extreme temperatures. The interior of a vehicle parked in the sun can reach 170 degrees Fahrenheit or more. In winter, the interior of the vehicle may drop below freezing.

Likewise, an instrument may also be transported from the humid air of Miami, Florida to the dry air of Las Vegas, Nevada in a matter of days while on tour. To protect instruments from these extreme conditions, artists may bring their instruments into restaurants and hotel rooms, a cumbersome and time-consuming process.

Traditional musical instrument cases are primarily designed to prevent physical damage and dust accumulation. Little, if any, protection is provided against outside environmental conditions such as temperature and humidity.

It would therefore be advantageous to have a device which avoids these and other drawbacks of existing storage methods and devices.

### SUMMARY OF THE INVENTION

In order to solve the problems with existing musical instrument cases, an environmentally-regulated portable music case is provided herein. An environmentally-regulated portable musical instrument case as disclosed herein may comprise a body having an internal cavity which is designed to hold a musical instrument and an apparatus for regulating the temperature in the internal cavity.

The musical instrument case may comprise a body and a lid which are hinged to allow easy access to the internal cavity. The body and lid may be insulated through the use of foam, fiberglass insulation, or a vacuum. A seal between the body and lid may be included to further insulate the internal cavity from the environment.

The temperature regulating device may be a thermoelectric device that can be powered by an on-board power source to allow the musical case to regulate temperature while being transported. A control panel with display may be used to set the desired internal temperature and monitor the conditions in the internal cavity without opening the case. Internal lights may be included to assist a user in viewing the contents of the case when it is opened and an exterior flashlight may be included to assist in transporting the musical instrument in dark environments.

The musical instrument case may further comprise a device for controlling the humidity in the internal cavity. A wireless communication device may allow the settings and conditions to be monitored or adjusted remotely from an electronic device. A GPS device may be built into the case to allow tracking of the case and reduce likelihood of theft of the case and musical instrument.

### BRIEF DESCRIPTION OF THE DRAWING

FIG. 1 depicts an environmentally-regulated portable musical instrument case according to one embodiment.

### DETAILED DESCRIPTION

Environmental fluctuations can change the tune or even damage a musical instrument. Musical instruments are frequently exposed to environmental fluctuations as the instruments are transported to various geographic locations, kept in vehicles, etc. To protect musical instruments from fluctuations, an environmentally-regulated portable musical instrument case is provided.

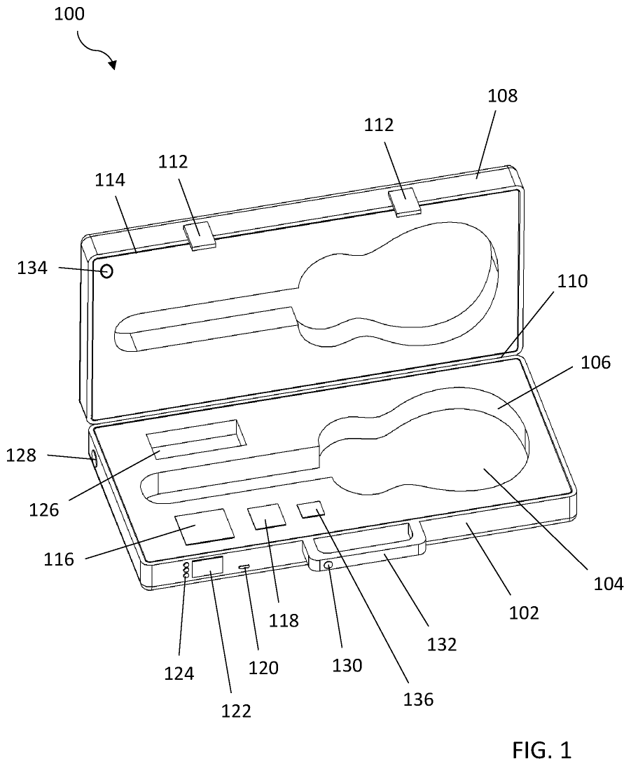

FIG. 1 depicts an environmentally-regulated portable musical instrument case 100 according to one embodiment. Case 100 is comprised of a body 102 having an internal cavity 104 designed to hold a musical instrument. Case 100 is designed to protect the musical instrument from physical damage, facilitate transport via a handle or strap, and to protect the instrument from external environmental conditions such as extreme heat, extreme cold, or humidity.

Body 102 is designed to thermally insulate internal cavity 104 from external conditions to provide a more stable internal temperature than non-insulted cases. Body 102 may be thermally insulated using any known methods. In one embodiment, body 102 is comprised of an inner layer of metal, an outer layer of metal, and an insulating layer between the two layers. The insulating layer may be glass fiber, foam, or any other insulating material. Body 102 may also be insulated through the use of a vacuum between an inner and an outer layer. Body 102 may be comprised of any number of layers of materials—including structural and insulating materials—and may be comprised of: metal, wood, polymers, fiberglass, carbon fiber, natural fibers, glass fibers.

Internal cavity 104 may be lined with a lining 106 to protect the instrument. For example, a felt lining may be used to prevent scratching and abrasion. The lining may also include a layer of padding, such as foam or batting to protect against impact damage. Lining 106 may provide additional thermal insulation for internal cavity 104 and material choice and layering for lining 106 may be chosen with thermal insulating in mind.

A lid 108 is attached to body 102 by use of one or more hinges 110 along one side of body 102, allowing access to the internal cavity 104. One or more latches 112 are placed along the other side of body 102 to secure lid 108 during storage and transport. Latches 112 may have a built-in lock or may be designed to accept a padlock. Body 102 and lid 108 may also have provisions for installing a lock. Lid 108 may be designed to be thermally-insulating as well and may use the same construction as body 102 or a different construction. Any of the methods and materials described with respect to body 102 may be applied to lid 108, including the lining. A seal 114 is designed to sit between body 102 and lid 108 and may prevent or reduce airflow between the internal cavity and the exterior environment, as well as prevent dirt or water ingress. Seal 114 may be made of any suitable material, such as rubber or foam.

The thermally-insulating design of body 102 and lid 108 will reduce the rate at which internal cavity 104 (and thus a musical instrument therein) changes temperature when exposed to environmental conditions. For some applications, insulation alont may be sufficient for the user. For extended lengths of time or extreme temperatures, it may be desirable to have additional methods of controlling the temperature within internal cavity 104. To accomplish temperature control, case 100 may further comprise a temperature regulating apparatus 116 to provide additional cooling or heating.

Temperature regulating apparatus 116 may be placed within the internal cavity of the case or in a portion of the case in thermal contact with the internal cavity. Temperature regulating apparatus 116 may function in a variety of ways, including Joule heating (also known as resistive heating), refrigeration (including cyclic and non-cyclic methods), and thermoelectric devices. Thermoelectric devices include Seebeck effect, Peltier effect, and Thomson effect devices.

Temperature regulating apparatus 116 may be powered by a power source such as a rechargeable battery 118. Rechargeable battery 118 may be built-in to case 100 or may be removable. An external power port 120 allows an external power source to power case 100 or recharge battery 118. External power port 120 may take the form of a USB-C port and may allow case 100 to be connected to household power (110V/220V), vehicle power (12V), solar panel, or external battery pack.

A display 122 can be used to convey the current temperature and humidity within internal cavity 104 as well as desired or recommended temperature and humidity. Display 122 can also display the state of charge of battery 118, the charging status, or warnings such as low battery or temperature warnings. A chime may provide an auditory alert that the battery is low or the internal conditions are out of range. Controls 124, such as buttons, knobs, or switches, may be used to control the functions of case 100, such as changing the internal temperature setting.

To help control humidity, a humidity control device may also be used. The humidity control device may be integrated with the temperature regulating apparatus or may be a separate device. The humidity control device may be as simple as a dessicant within the case. A compartment 126 in the internal cavity may hold the humidity control device.

Musical instruments are often transported outside between a vehicle and a venue at night. External light 128 controlled by switch 130 on handle 132 can be used as a flashlight to illuminate the darkness for added convenience and safety. The light may be an LED and may be any color such as white or red. Multiple light colors or brightnesses may be provided, allowing the user to select an appropriate light for the circumstances. External light 128 may be powered by the same power source as the temperature regulating apparatus or by a separate power source.

Additionally, internal light 134 may be used to illuminate the inside of the case. The internal light may be controlled by a switch or may turn on automatically upon opening the case and off when closing the case. The internal light 134 may be any color such as white or red and may be powered by the same power source as other devices or by a separate power source.

A GPS tracker 136 may be built into the case to allow an owner to monitor the location of equipment in transit or track stolen equipment. The GPS tracker may be accessible through an application, such as a smartphone app. The smartphone app may also be used to monitor conditions inside the case, including temperature and humidity as well as monitor the power source. The app may be capable of receiving the state of charge and charging status of the power source and may alert the user of low power or if internal conditions are out of a set range. Additionally, the app may be capable of adjusting the settings such as the temperature setting of the internal cavity. A wireless communications device may be used to connect directly with a device running the app or may communicate through wireless networks such as wifi or cellular phone towers.

It is contemplated that such an environmentally-regulated musical instrument case could take many forms without departing from the spirit of the invention. For example, temperature may also be regulated through the use of a thermal pack which may be heated in a microwave or cooled in a refrigerator or freezer before being placed in the case. A thermal pack which uses a chemical reaction to create a temperature change may also be used.

The discussion herein of the present invention is directed to various embodiments of the invention. The term “invention” is not intended to refer to any particular embodiment or otherwise limit the scope of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Herein, the terms “including,” “consisting of”, and “comprising” are used in an open-ended fashion, and thus should be interpreted to mean “including, but not limited to.” Also, the term “connect” or “connected” where used if at all is intended to mean either an indirect or direct connection. Thus, if a first component connects to a second component, that connection may be through a direct connection or through an indirect connection via other components and connections.

Certain terms are used throughout the description and claims to refer to particular system components and method steps. As one skilled in the art will appreciate, different companies may refer to a component by different names. This document does not intend to distinguish between components that differ in name but not function.

It is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A musical instrument case, comprising:
a body having an internal cavity deigned to hold a musical instrument; and
a temperature regulating apparatus for altering the temperature within the internal cavity.

2. The musical instrument case of claim 1, wherein the temperature regulating apparatus comprises a thermoelectric effect device.

3. The musical instrument case of claim 1, further comprising:
a display for conveying the environmental conditions within the internal cavity to a viewer.

4. The musical instrument case of claim 1, further comprising:
a power source connected to the temperature regulating apparatus.

5. The musical instrument case of claim 1, further comprising:
a flashlight.

6. The musical instrument case of claim 1, further comprising:
a lid attached to the body by a hinge; and
a seal between the body and the lid.

7. The musical instrument case of claim 1, wherein the body is thermally-insulated.

8. The musical instrument case of claim 7, wherein the body is comprised of two layers of metal with an insulating layer between the two layers.

9. The musical instrument case of claim 8, wherein the insulating layer comprises one or more of: foam, fiberglass, a vacuum.

10. The musical instrument case of claim 1, further comprising:
a humidity control device.

11. The musical instrument case of claim 1, further comprising:
a GPS device.

12. The musical instrument case of claim 1, further comprising:
a wireless communication device.

13. A musical instrument case, comprising:
a thermally-insulated body having an internal cavity deigned to hold a musical instrument;
a temperature regulating apparatus for altering the temperature within the internal cavity; and
a power source connected to the temperature regulating apparatus.

14. The musical instrument case of claim 13, wherein the temperature regulating apparatus comprises a thermoelectric effect device.

15. The musical instrument case of claim 13, further comprising:
a display for conveying the environmental conditions within the internal cavity to a viewer.

16. The musical instrument case of claim 13, wherein the body is comprised of two layers of metal with an insulating layer between the two layers.

17. The musical instrument case of claim 16, wherein the insulating layer comprises one or more of: foam, fiberglass, a vacuum.

18. The musical instrument case of claim 13, further comprising:
a humidity control device.

19. The musical instrument case of claim 13, further comprising:
a GPS device.

20. The musical instrument case of claim 13, further comprising:
a wireless communication device.
